(19) United States
(12) Patent Application Publication
(10) Pub. No.: US 2007/0173078 A1
(43) Pub. Date: Jul. 26, 2007

(54) Volute Spring

(76) Inventors: Claudia Reck, Darmstadt (DE); Michael Mueller, Darmstadt (DE); Volker Seipel, Bensheim (DE)

Correspondence Address: BARLEY SNYDER, LLC, 1000 WESTLAKES DRIVE, SUITE 275, BERWYN, PA, 19312, US

(21) Appl. No.: 11/625,530

(22) Filed: Jan. 22, 2007

(30) Foreign Application Priority Data
Jan. 26, 2006 (DE) 102006003692.1

(51) Int. Cl. H01R 39/00

(52) U.S. Cl. 439/15

(57) ABSTRACT

A volute spring for a steering system, having a stator with a fixed bearing, the stator being substantially coaxial with an axis of rotation, a rotor opposing the stator, the rotor being rotatable about the axis of rotation and the rotor being located substantially concentric with the stator and coaxial with the axis of rotation, and an axle protruding from the stator and extending through the stator, the axle cooperating with the fixed bearing, where an at least partially circumferential area of a radial section of stator is located between the axial section of the rotor and a ring associated with hollow axle, thereby axially and radially securing the rotor with respect to the stator is disclosed.

### CROSS-REFERENCE TO RELATED APPLICATIONS

This application claims the benefit of the filing date under 35 U.S.C. §119(a)-(d) of foreign patent application DE 10 2006 003 692.1 filed Jan. 26, 2006.

### FIELD OF THE INVENTION

The invention relates to a volute spring for use in a steering system and more particularly to a volute spring for use in a steering system of an automobile.

### BACKGROUND

In the automobile industry, volute springs serve to transmit data and/or signals between a vehicle's rotatable steering wheel and the vehicle's electrical and electronics systems, respectively. Volute springs are useful in safety systems and devices such as an airbag to ensure a dependable electrical connection which does not allow any interruption or delay of an electrical pulse. In addition, through electric lines in vehicle switches, volute springs serve to electrically connect vehicle sensors and/or other electrical/electronic components which are connected to the steering wheel (e.g. for horn, radio, navigation system, warning light, headlights, steering-wheel heating etc.) with corresponding components or evaluation units which do not rotate with the steering wheel.

A volute spring may be located on a steering column bracket of the steering wheel and consist of a basically cylindrical, stationery component and a basically cylindrical, rotatable component which is mounted on the steering wheel. The rotatable component is movable in relation to the vehicle and is arranged basically concentrically in relation to the stationery component. Together, the stationery component and the rotatable component form a hollow housing for the volute spring.

The stationery and rotatable components, are interconnected with plastic tape integrating conducting tracks (a flexible ribbon cable) which are located in a cavity formed by the juxtaposition of the stationery component and the rotating component. In so-called “short flat spiral springs”, the flexible ribbon cable is bent in the spring housing (hence also sometimes called a bendback volute spring), with one end of the flexible ribbon cable being connected to the rotatable component and the other end of the flexible ribbon cable to the stationery component.

Turning the rotatable component in a first direction of rotation, the flexible ribbon cable already wound onto an inside of the stationery component is unwound by the stationery component, guided by a cable bend and is wound onto and outside of the smaller-diameter rotating component; on the other hand, turning the rotating component in the other direction of rotation, the flexible ribbon cable already wound onto the rotating component is unwound, transported by the cable bend and is again wound onto the inside of the larger-diameter stationery component. For use in modern automobiles, volute springs must be capable of about five complete revolutions of the steering-wheel, i.e. from the straight-ahead driving position of the steering wheel about two-and-a-half revolutions in each have a clockwise and counter-clockwise rotation.

A volute spring should be robust and built structurally simply from few parts to be fit for reliable use in the steering of an automobile and to enable inexpensive production. Similarly, the housing of the volute spring (the stationery component and the rotating component) should be formed with reliability and ease of production in mind. The rotating component may be supported in and on the stationery component.

U.S. Pat. Nos. 5,904,585 and 5,772,146 each disclose a volute spring housing, whereby a rotor is supported in radial and axial direction on a volute spring stator. In this case the rotor is axially supported on two stator sides facing in opposite directions. A first bearing face for the axial support is in an outer radially circumferential area between rotor and stator, with an inner rotor surface cooperating with an outer stator surface. A second bearing face for the axial support is provided between a portion of the rotor and a boring in the stator bottom, whereby the rotor is engaged in the stator in an inner radially circumferential area, which additionally provides radial support for the rotor in the stator.

The volute spring housings disclosed in the above described references consist of a minimum of three individually formed single parts and are, therefore, of a relatively complicated structure and comparatively expensive to produce and assemble. Moreover, the axial bearing faces which are located far apart from one another are relatively costly to produce to a predetermined tolerance.

The trend towards miniaturization in the automobile industry as well as increased replacement of mechanical vehicle components by electronic or electromechanical devices (such as a drive-by-wire steering) continues. As automobile systems decrease in size, the space allocated to those systems also decreases. Therefore, space for components such as a volute spring is reduced. Consequently, a smaller, yet robust, volute spring is needed.

### SUMMARY

The present invention relates to a volute spring for a steering system, having a stator with a fixed bearing, the stator being substantially coaxial with an axis of rotation, a rotor opposing the stator, the rotor being rotatable about the axis of rotation and the rotor being located substantially concentric with the stator and coaxial with the axis of rotation, and an axle protruding from the stator and extending through the stator, the axle cooperating with the fixed bearing, where an at least partially circumferential area of a radial section of stator is located between the axial section of the rotor and a ring associated with hollow axle, thereby axially and radially securing the rotor with respect to the stator.

An objective of the invention is to provide an improved volute spring, in particular an improved volute spring housing. In particular, the volute spring should be constructed in a simple and robust way, have small dimensions and moreover be inexpensive to manufacture. The rotor bearing in the stator should be provided through as simple, robust, and space-saving connection.

### BRIEF DESCRIPTION OF THE DRAWINGS

Further details, advantages and features of the present invention will become apparent from the following description of an exemplary embodiment together with the drawings, in which:

FIG. 1 is an oblique exploded view of a volute spring according to the invention; and

FIG. 2 is an oblique cut-away view of the volute spring of FIG. 1 shown in cooperation with a steering gear shaft.

### DETAILED DESCRIPTION OF THE EMBODIMENT(S)

References in the following description to a pressed and/or crimped connection between a steering gear shaft of a steering and a metal hollow axle 22 (metal shaft) of a rotor are deemed to mean a mainly positive connection which may have some non-positive elements. Further while the present invention is described as applied generally to automobiles, the present invention may also be used in steering systems of other land or water craft.

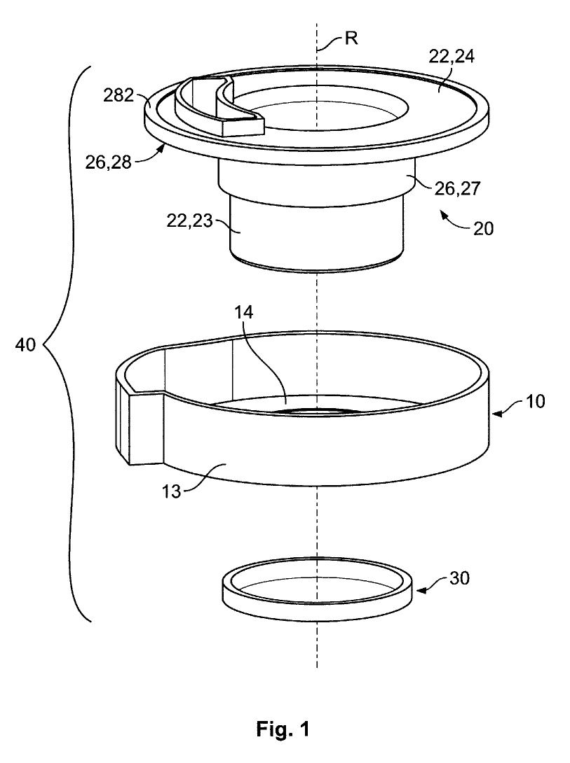

FIG. 1 shows an exploded view of a volute spring 1 prior to its assembly. The volute spring 1 comprises a housing 40 built of two components, a rotor 20 and a stator 10. The volute spring 1 further comprises a ring 30 to hold the rotor 20 on the stator 10 while still allowing the rotor 22 turn inside the stator 10 about an axis of rotation R. The ring 30 also secures the rotor 20 in a position relative to the longitudinal directions of axis of rotation R. The ring 30 is a snap ring, but may alternatively be formed as an at least partially circumferential projection on rotor 20 or may be constructed as any other suitable form.

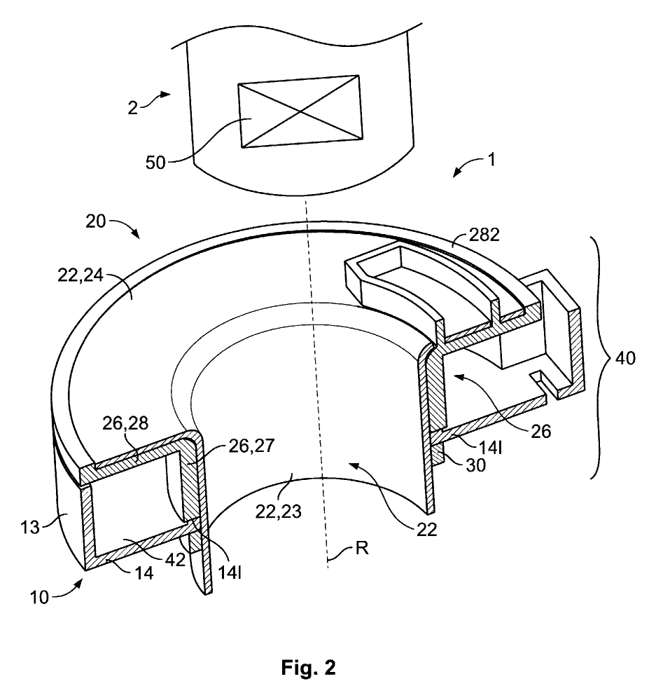

Rotor 20 is a revolving component and is basically built to be rotationally symmetrical and has an L-shaped generatrix (a two-dimensional shape offset from and revolved about axis of rotation R) which with its short leg runs around the top (of FIG. 1) of the axis of rotation R and thus gives rotor 20 a T-shaped appearance as viewed from the side. Rotor 20 has a clearance at the top (see top left in FIG. 1 and right in FIG. 2) which, when provided with an edge or a projection running around the entire clearance, forms a receptacle for a plug or for electrical connections of a flexible ribbon cable (not illustrated in the figures) located in volute spring 1.

Rotor 20 comprises two components permanently joined together, a rotor body 26 and a hollow axle 22, where the latter may be manufactured entirely from metal or a metal alloy. Rotor 20 may be formed by an injection-molding process, with the metal hollow axle 22 being inserted as a core into the injection mold for rotor 20 and the rotor body 26 being cast onto the metal hollow axle 22. This process permanently joins the metal hollow axle 22 and the rotor body 26 during molding. In other words, after molding, a complete rotor 20 results from the injection molding process. However, rotor 20 can be manufactured in other ways, for example, metal hollow axle 22 may be inserted into rotor body 26 and permanently joined to it through the use of glue or screws. Rotor 20 may be shaped as if a first L-shaped profile is offset from and rotated above axis of rotation R and a second L-shaped profile is similarly offset from and rotated about the axis of rotation R situation in close relation to the first L-shaped profile in a manner which produces the shape of rotor 20.

Thus, the metal hollow axle 22 comprises an axial section 23 and a radial section 24, and rotor body 26 comprises an axial section 27 and a radial section 28. The large areas of each of radial sections 24 and 28 and axial sections 23 and 27 are touching, with rotor body 26 being arranged outside the metal hollow axle 22.

The axial section 23 of metal hollow axle 22 is longer than axial section 27 of rotor body 26. Furthermore, radial section 28 of rotor body 26 is made longer or extends further outwards in radial direction than radial section 24 of metal hollow axle 22. Radial section 24 of metal hollow axle 22 is adjoined on the outside by a collar 282 of radial section 28 of rotor body 26, with collar 282 surrounding the radial section 24 of metal hollow axle 22 in an at least partially circumferential manner at the edge and preferably terminates substantially in plane with an upper side of radial section 24, most clearly shown in FIG. 2.

Like rotor 20, stator 10 (the stationary component) is a basically rotationally symmetrical component formed by an L-shaped generatrix, as compared to the generatrix of the rotor 20, rotated about axis of rotation R, but where the generatrix of the stator 10 lies rotated 180° in relation to an axis perpendicular to the axis of rotation R.

A facility or device for a plug or electrical connections for one or several flexible ribbon cables is provided on stator 10, has shown on the left in FIG. 1 and on the right in FIG. 2. Stator 10 further has a circular clearance in the center of its bottom through which axial section 23 of metal hollow axle 22 can be inserted. The circular clearance is made slightly larger than an outer dimension of axial section 23.

Analogously to rotor 20, stator 10 has a basically axial section 13 and a radial section 14 (bottom). The axial section 13 of stator 10 stands upright on the radial section 28 of rotor body 26 and the radial section 14 of stator 10 stands upright on the axial section 23 of metal hollow axle 22 or axial section 27 of rotor body 26 when the volute spring 1 is assembled.

FIG. 2 shows volute spring 1 in its assembled state, wherein a steering gear shaft 2 (or steering rod) of a steering system to be connected with rotor 20 of volute spring 1 is shown. When volute spring 1 is mounted on the steering, the metal hollow axle 22 is permanently connected to steering gear shaft 2 of rotor 20. This is accomplished by a positive and/or self-substance connection. Positive connections may include crimping, press fitting, and shrinking, as well as self-substance connections such as molding, welding, and gluing. In particular, it is possible to crimp metal hollow axle 22 to the steering gear shaft. For this purpose at least an area 50 is preferably provided at an appropriate location of steering gear shaft 2 to which the metal hollow axle 22 is crimped.

To assemble rotor 20, stator 10, and steering gear shaft 2, it is possible to first permanently connect rotor 20 with steering gear shaft 2 and then subsequently provide rotor 20 on stator 10. Alternatively, it is possible to first connect rotor 20 with stator 10 and then subsequently connect steering gear shaft 2 with the rotor 20. To achieve close fitting of rotor 20 to or on steering gear shaft 2, a relevant inner diameter of metal hollow axle 22 is slightly larger in axial section 23 than an external diameter of steering gear shaft 2.

Referring to FIG. 2, volute spring 1 is illustrated cut open in an axial direction along the axis of rotation R. In the assembled state of the volute spring 1, one leg each of the L-shapes of the rotor 20 and stator 10 stand upright on one leg of the L-shapes of each other so that a housing cavity 42 is produced between rotor 20 and stator 10. At least one flexible ribbon cable is housed within housing cavity 42. The housing cavity 42 formed by rotor 20 and stator 10 is easy to recognize as being rotationally symmetrical and having a rectangular generatrix, which gives the cavity 42 a torus-shaped appearance.

With volute spring 1 assembled, at least one ribbon cable is electrically connected to stator 10 at its cylindrical inner side (outer internal area of volute spring housing 40) via an electrical connection, with a first longitudinal end section of the flexible ribbon cable (which may be shorter or longer depending on the turning position of the steering wheel) being guided spirally along the inner wall of stator 10 to the inside of volute spring housing 40. The flexible ribbon cable is folded at a 180° bend (where the bend causes the cable to press against the inside of the stator 10), pushing a second longitudinal end section of the flexible ribbon cable (which may be shorter or longer depending on the turning position of the steering wheel) away from stator 10 toward rotor 20 and winding the cable onto the cylindrical outer side of rotor 20 (inner internal area of volute spring housing 40). This causes the second longitudinal end section to lie with opposite winding orientation with respect to the first longitudinal end section. The second longitudinal end section is electrically connected to an electrical connection on rotor 20. Alternatively, the relevant electrical connections on stator 10 and on rotor 20 may be not be necessary where the flexible ribbon cable is guided through stator 10 and/or rotor 20 and electrically connected with the vehicle electronics using a plug or a bushing outside the stator 10 and/or rotor 20. The ribbon cable(s) inside volute spring 1 are guided by guide bodies which can move along housing cavity 42 around the axis of rotation R.

Still referring to FIG. 2 in the drawings, an axial and radial bearing of rotor 20 in stator 10 is shown. A circumferential area which guides rotor 20 axially and radially in relation to stator lies inside volute spring 1. In alternative embodiments of the present invention, additional axial bearings may be provided between rotor 20 and stator 10.

The radial bearing of rotor 20 is formed between a free end of axial section 13 of stator 10 and an outer border area of radial section 28 of rotor body 26 (this may alternatively be provided by radial section 24 of metal hollow axle 22) forming a substantially circumferential bearing area of rotor 20 on stator 10. The bearing area is shaped in the form of a seal, such as a labyrinth seal, between rotor 20 and stator 10 which prevents impurities from getting into volute spring 1.

The axial and radial bearing arrangement of rotor 20 and stator 10 is shown between radial area 14 of stator 10 and rotor 20. An inner radial area of radial section 14 of stator 10 is clamped here between a free end of axial section 27 of rotor body 26 and ring 30 (which is an integral part of metal hollow axle 22 or fixed to axle 22). The at least partially circumferential, inner free end of radial section 14 of stator 10 abuts against the outer wall of metal hollow axle 22, with a predetermined space between these two so that rotor 20 can turn in relation to stator 10. Further, a predetermined axial space is provided between axial section 27 of rotor body 26 and ring 30 as well as between the radial area of radial section 14 of stator 10 and other components as necessary to allow relative rotation between rotor 20 and stator 10.

Bearing faces of the inner area of radial section 14 can be provided with a circumferential radial collar 141 whose radial dimension is less than the radial dimension of the free end of axial section 27 of rotor body 26. Radial collar 141 supports rotor 20 axially and radially in stator 10. The radial collar is generally U-shaped where the two circumferential legs of the U-shape serve as axial bearing faces whereas the circumferential bridge between the legs of the U-shape serves as a radial bearing. The two axial bearing faces are substantially parallel and offset from one another and at a 90° angle to the axis of rotation R. In an alternative embodiment of the present invention, the two legs may not be parallel but form an angle between the two legs, where the arrangement provides appropriate guidance to a complementarily shaped portion of the relevant area of radial section 14 of stator 10. In alternative embodiments of the present invention, two such radial collars 141 lying opposite each other in relation to radial section 14 may be provided. In this way the invention achieves a simple and compact rotor 20 bearing arrangement in the stator 10, which radially runs around the entire axle 22. This bearing face arrangement is constructed simply and can be manufactured at low cost with short processing times.

In another alternative embodiment, the innermost free end of radial section 14 of stator 10 (representing the bore wall in housing bottom) may be formed as a spherical design so as to achieve a line contact between radial section 14 of stator 10 and axial section 23 of metal hollow axle 22. Such a spherical shape may also be adopted for the two axial bearing faces. More specifically, the radial collar(s) 141 and/or the free end of axial section 27 of rotor body 26 and/or the upper end of collar 30 may be spherically shaped.

Ring 30 is pressed and/or welded onto metal hollow axle 22. Other connections such as gluing or screwing are of course possible. Pressing and/or welding the ring 30 ensures, on the one hand, that the rotor 20 is easily fit into the stator 10, and on the other hand, provides the rotor 20 with a secure and permanent axial bearing in one axial direction. To produce a press fit between ring 30 and axle 22 it may be advantageous to slit the metal ring 30 and provide it as a spring washer on the axle 22. To permanently prevent the ring 30 from slipping down, the ring may additionally be held radially outward from the axle 22 by means of a notch or molding of the material. To secure ring 30 on metal hollow axle 22, the latter may have a notch or molded feature protruding outward. The notch or molded feature may be made here by pressing or punching out the material of metal hollow axle 22.

Further, it is also possible to provide spring notches which fold inward when ring 30 contacts and/or brushes over them (coming from below) and then later fold outward once ring 30 has been pushed over and/or axially past the spring notches. The spring notches serve to fix ring 30 in the axial direction on metal hollow axle 22.

Alternatively, ring 30 may be formed of the same material in one piece with metal hollow axle 22, which would require a different assembly of volute spring 1 or modifications of volute spring 1. A ring 30 made of the same material as and in one piece with metal hollow axle 22 may also be made as an at least partially circumferential embossing of metal hollow axle 22. The above described molding for axle 22 may be altered to provide the integrated ring 30 by adjusting the molding on its upper side so as to obtain a defined bearing face.

Still further, ring 30 may alternatively be replaced by several projections which are again made of the same material as and in once piece with metal hollow axle 22 or are joined to the metal hollow axle 22 using one of the above mentioned joining methods.

Where ring 30 is a snap ring 30, snap ring 30 is suitable for being inserted in a circumferential groove in axle 22 (around axis of rotation R), with the groove plane being substantially perpendicular to the axis of rotation R. This snap ring 30 and groove arrangement provides a simple and quick mechanism for axial fixing of rotor 20 on stator 10 using a standard existing and commercially available part with known and defined properties, such as a DIN standard part.

According to the present invention, rotor 20 and stator 10 may each be formed as one piece. This reduces the production cost of the volute spring 1 and makes the volute spring 1 easy to assemble. The stator 10 may be manufactured from one material by a plastic injection-molding process. The rotor 20 is also may be made by a plastic injection-molding process, with at least the axial section consisting of plastic, where the axle 22 serves as core being inserted into the injection mold and the remaining portion of the rotor (axial section with radial section integral to it) being cast or injection-molded onto the axle 22 in the injection-molding process.

What is claimed is:

1. A volute spring for a steering system, comprising:
a stator having a fixed bearing, the stator being substantially coaxial with an axis of rotation;
a rotor opposing the stator, the rotor being rotatable about the axis of rotation and the rotor being located substantially concentric with the stator and coaxial with the axis of rotation; and
an axle protruding from the rotor and extending through the stator, the axle cooperating with the fixed bearing;
wherein an at least partially circumferential area of a radial section of stator is located between the an axial section of the rotor and a ring associated with a hollow axle, thereby axially and radially securing the rotor with respect to the stator.

2. The volute spring according to claim 1, wherein the ring is pressed onto the axle.

3. The volute spring according to claim 1, wherein the ring is welded onto the axle.

4. The volute spring according to claim 1, wherein the ring is held in position with respect to the axle using a notch formed in the axle.

5. The volute spring according to claim 1, wherein the ring is held in position with respect to the axle using a molding formed on the axle.

6. The volute spring according to claim 1, wherein the ring is a slit snap ring arranged in a groove provided in an outer wall of the axle.

7. The volute spring according to claim 1, wherein the axle is capable of being connected to a steering gear shaft by a positive connection.

8. The volute spring according to claim 1, wherein the axle is capable of being connected to a steering gear shaft by a self-substance connection.

9. The volute spring according to claim 1, wherein a positive connection between the axle and a steering gear shaft is a pressed connection.

10. The volute spring according to claim 1, wherein a positive connection between the axle and a steering gear shaft is a crimped connection.

11. The volute spring according to claim 1, wherein a self-substance connection between the axle and a steering gear shaft is a welded joint.

12. The volute spring according to claim 1, wherein the axel is inserted into a rotor body of the rotor, each of the rotor body and the axle are substantially rotationally symmetrical, each of the rotor body and the axle have L-shaped generatrix, and the L-shaped generatrixes lie one against the other with their respective legs.

13. The volute spring according to claim 1, wherein the stator is substantially rotationally symmetrical and has an L-shaped generatrix, wherein one leg each of the L-shaped generatrix of the stator stands upright on a leg of the L-shaped generatrix of the rotor body such that a substantially torus-shaped housing cavity is formed.

14. The volute spring according to claim 13, wherein the housing cavity has a substantially rectangular generatrix.

15. The volute spring according to claim 1, further comprising:
a radial collar formed on the stator and located between an axial section of stator and a radial section of rotor body.

16. The volute spring according to claim 1, wherein a rotor body is molded onto the axle.

17. The volute spring according to claim 1, wherein the axle is constructed at least partially of iron.

18. The volute spring according to claim 1, wherein the axle is constructed at least partially of aluminium.

19. A steering system, comprising:
a stator having a fixed bearing, the stator being substantially coaxial with an axis of rotation;
a rotor opposing the stator, the rotor being rotatable about the axis of rotation and the rotor being located substantially concentric with the stator and coaxial with the axis of rotation; and
an axle protruding from the stator and extending through the stator, the axle cooperating with the fixed bearing;
wherein an at least partially circumferential area of a radial section of stator is located between the an axial section of the rotor and a ring associated with a hollow axle, thereby axially and radially securing the rotor with respect to the stator.

20. The steering system according to claim 19, wherein the axle is capable of being connected to a steering shaft by a positive connection.
